(19) United States
(12) Patent Application Publication
(10) Pub. No.: US 2023/0371502 A1
(43) Pub. Date: Nov. 23, 2023

(54) A METHOD FOR TREATING A BIOLOGICAL MATERIAL

(71) Applicant: OPTICEPT TECHNOLOGIES AB, LUND (SE)

(72) Inventors: Eda DEMIR WESTMAN, STAFFANSTORP (SE); Katarzyna Maria DYMEK-KRAKOWIAK, LUND (SE); Bengt EKELUND, LUND (SE); Per LILJA, LIMHAMN (SE); Nils RHODIN, LUND (SE); Stephen KWAO, LUND (SE); Ahmad HUSAIN, LUND (SE)

(21) Appl. No.: 18/030,739

(22) PCT Filed: Oct. 22, 2021
(86) PCT No.: PCT/SE2021/051058

§ 371 Date: Apr. 6, 2023

(30) Foreign Application Priority Data
Oct. 23, 2020 (SE) 2051240-6
Jan. 19, 2021 (SE) 2150047-5

(51) Int. Cl. A01N 3/02

(52) U.S. Cl. CPC A01N 3/02

(57) ABSTRACT

The present invention describes a method for treating a biological material, said method comprising exposing the biological material to vacuum impregnation or pressure impregnation, preferably vacuum impregnation, in an aqueous impregnation solution comprising at least one surfactant.

### FIELD OF THE INVENTION

The present invention relates to a method for treating a biological material.

### SUMMARY OF THE INVENTION

The present invention relates to a method for treating a biological material, said method comprising exposing the biological material to vacuum impregnation or pressure impregnation, preferably vacuum impregnation, in an aqueous impregnation solution comprising at least one surfactant. Preferably, the method is performed with vacuum impregnation. Furthermore, preferably the method is performed with vacuum impregnation in an aqueous impregnation solution without performing a prior, simultaneous or subsequent PEF (pulsed electrical field) treatment. The method according to the present invention is then performed free from any form of PEF treatment, in fact preferably free from any other active treatment step but the vacuum impregnation step. In this regard using at least one surfactant according to the present invention increases the effect of the vacuum impregnation.

Furthermore, by using a surfactant in the impregnation solution, water is leaving the biological material, e.g. plants or cut flowers, faster during the treatment. This is preferred as if water remains this may spoil such plants and cut flowers.

Moreover, by using a surfactant in the impregnation solution according to the present invention, this enables to treat certain biological material, such as e.g. cut flowers, with short vacuum impregnation cycles. This is further mentioned and discussed below.

### SPECIFIC EMBODIMENTS OF THE INVENTION

Some specific embodiments of the present invention are disclosed further below.

According to one specific embodiment, said at least one surfactant is an anionic surfactant.

As hinted above, according to yet another embodiment of the present invention, the method is performed without performing a prior, simultaneous or subsequent PEF (pulsed electrical field) treatment.

Furthermore, according to yet another embodiment, the method involves vacuum impregnation in at least three phases, said at least three phases being a pressure falling step when the pressure is decreased to a certain low pressure, then a pressure holding step in which the low pressure is kept or substantially kept at the low pressure, and a pressure rising step where the pressure is increased to atmospheric level. In one embodiment, the pressure falling step is performed during a time of maximum 10 minutes, preferably maximum 5 minutes, more preferably maximum 3 minutes. According to yet another embodiment, the pressure holding step is performed during maximum 5 minutes, preferably maximum 3 minutes, more preferably maximum 2 minutes. Furthermore, according to another embodiment, the pressure rising step is performed during maximum 10 minutes, preferably maximum 5 minutes, more preferably maximum 3 minutes.

Moreover, according to yet another embodiment, the method involves vacuum impregnation in a minimum pressure range of 50-500 mbar, preferably in the range of 60-300 mbar.

Furthermore, according to one embodiment, the aqueous impregnation solution comprises at least one sugar being glucose, trehalose and/or fructose, or a sugar alcohol, preferably sorbitol or glycerol, or a combination thereof.

Also other steps may be involved in the process according to the present invention. According to one specific embodiment, the method also comprises applying a drying step to the biological material, subsequent to vacuum impregnation, for removing water/moisture from surfaces of the plant material before packing the treated plant material.

Different types of biological material may be the target material. According to one embodiment, the biological material is a plant material, preferably a plant material comprising one or more sprouts, cuttings or cut flowers, preferably cuttings or flowers

According to yet another embodiment, the method is performed for treating one or more cut flowers each comprising a stem, possibly one or more leaves and a flower bud, and wherein said method comprises
arranging one or more cut flowers in an impregnation solution so that at least a portion of the stem of said one or more cut flowers are immersed in the impregnation solution, but where the flower bud is free from impregnation solution; and
applying vacuum impregnation or pressure impregnation, preferably vacuum impregnation, to the impregnation solution when said at least portion of the stem are immersed into the impregnation solution,
   wherein the method is performed during one or more short cycles of applying vacuum impregnation or pressure impregnation, each short cycle being performed during maximum 3 minutes, preferably maximum 1 minute, more preferably in the range of 5 seconds-1 minute.

Furthermore, also other additives may be relevant according to the present invention. According to one embodiment, the impregnation solution comprises at least one additive being a vitamin, mineral, ethylene controller, hormone, e.g. a growth hormone, nutrient, antimicrobial, fertilizer, anti-foaming agent, or a combination thereof. According to another embodiment, the impregnation solution comprises at least one additive of folic acid, gamma-aminobutyric acid (GABA), ethylene blockers, e.g. 1-methylcyclopropene (1-MCP), pantothenic acid, amino acids, e.g. cysteine, plant hormones, e.g. IBA, an antiseptic agent, e.g. silver nitrate, or a combination thereof.

Moreover, according to one embodiment of the present invention, the impregnation solution comprises at least one silver containing substance, and wherein the silver content is at least 3.0 mg/kg dry substance in said at least one or more leaves, preferably at least 5.0 mg/kg dry substance in said at least one leaf, more preferably at least 7.0 mg/kg dry substance in said at least one leaf, more preferably at least 10.0 mg/kg dry substance in said at least one leaf, more preferably at least 15.0 mg/kg dry substance in said at least one leaf, more preferably at least 20.0 mg/kg dry substance in said at least one leaf, more preferably at least 25.0 mg/kg dry substance in said at least one leaf, most preferably at least 30.0 mg/kg dry substance in said at least one leaf, after treatment, preferably as measured up to at least 7 days after treatment, more preferably as measured up to 14 days after treatment.

Preferably, the cut flower also comprises where the silver content is at least 10.0 mg/kg dry substance in the stem after treatment, preferably as measured up to at least 7 days after treatment, more preferably as measured up to 14 days after treatment.

Also other steps are possible in a method according to the present invention. According to one embodiment, the method also comprises an active step for preventing microbial contamination of the aqueous impregnation solution. Moreover, according to yet another embodiment, the active step for preventing microbial contamination involves adding one or more antimicrobial agents to the aqueous impregnation solution, preferably wherein the active step for preventing microbial contamination involves an active treatment of the aqueous impregnation solution. Also other steps may be involved with this purpose. One example is where one or more growth agents are added to the aqueous impregnation solution. Another alternative is to ensure that the aqueous impregnation solution is recirculated and reused, and thus preferably as an active step for preventing microbial contamination.

According to yet another embodiment, the method involves a subsequent washing step comprising immersing the treated biological material into water to wash sugars from the surface of the treated biological material. Furthermore, according to one embodiment, the biological material is directly subjected to a cooling step after the washing step, said cooling step being a recovering step. Moreover, the cooling step may suitably be performed at a temperature of 5-10° C. Furthermore, according to one specific embodiment, the cooling step is performed during at least 6 hours, preferably at least 12 hours. In relation to the above it should be mentioned that freezing may be employed in some cases instead of cooling. Therefore, according to one embodiment, the method involves a subsequent freezing step.

Furthermore, according to one embodiment, the impregnation is a partial impregnation, preferably wherein the impregnation is a partial impregnation where the biological material receives a maximum of a 50% weight gain after the partial impregnation.

Moreover, according to one embodiment, a resting period is applied subsequent to the vacuum or pressure impregnation. The resting period is suitably performed in a relative humidity of at least 60% and in a temperature range of 4-10° C. Furthermore, according to yet another embodiment, the resting period involves removing water from surfaces of the plant material. According to yet another embodiment, the resting period involves putting the biological material on a net material to remove water from surfaces of the biological material.

According to one embodiment, the method involves storing the biological material in a controlled storing environment. Suitably, the storing environment involves a temperature of 4-10° C. Moreover, the storing environment suitably involves a humidity of above 50%. As may be noted, suitably the storing environment is similar to a resting period environment. Moreover, according to yet another embodiment, the storing is performed by incorporating the biological material into one or more package with modified atmosphere.

### Experiments

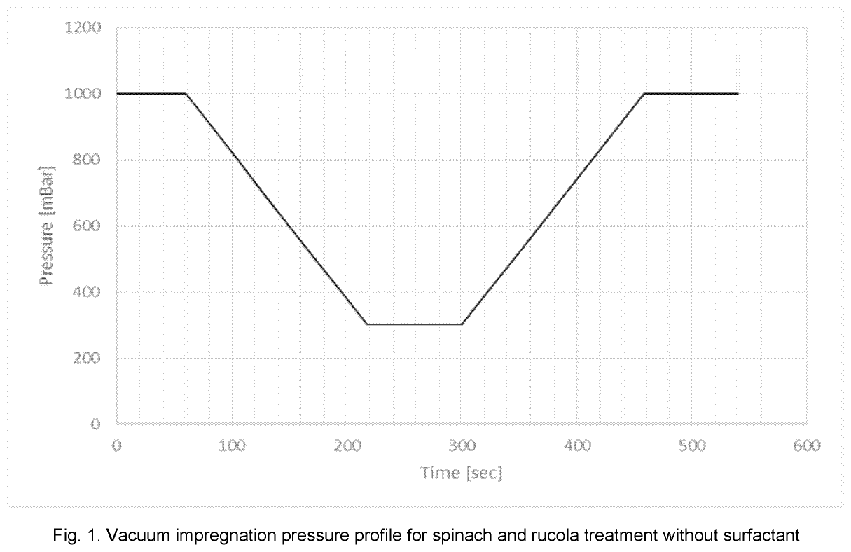

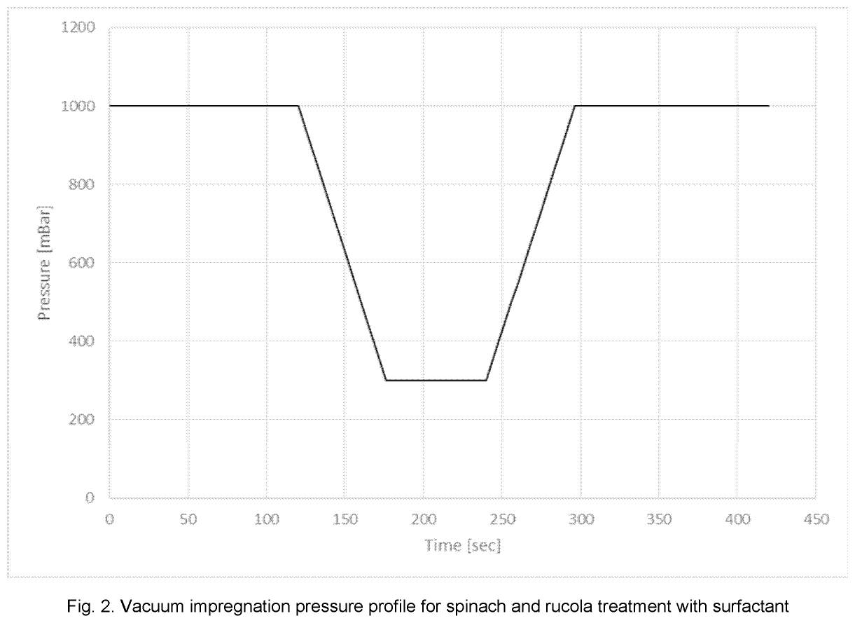

Comparative trials were made with vacuum impregnation with only one treatment cycle according to the present invention. In FIGS. 1 and 2 there are shown treatments according to the present invention for spinach and rucola, without (see FIG. 1) the use of a surfactant and with a surfactant (see FIG. 2) included in the impregnation solution. The results of the treatments were satisfying in both cases, however in accordance with the present invention, it is possible to include one or more surfactants in the impregnation solution to enable for a faster treatment cycle and still obtain at least the same level of result. In this case the total time from the pressure decrease until going back to atmospheric pressure again should be compared, and as notable, with the use of a surfactant this total time is shorter.

By using a surfactant according to the present invention, the surface tension of the impregnation solution is broken, which in turn enables to provide much more of the active components (treatment liquid) into the biological material intended to be treated by vacuum impregnation. Furthermore, different types of surfactants may be used. One example of a commercially available surfactant possible to use is Greenfain.

Moreover, according to one embodiment of the present invention, said at least one surfactant is an anionic surfactant. Anionic surfactants which are readily biodegradable may be relevant to use according to the present invention.

Furthermore, comparative trials were also made to investigate the effect of excluding a step of applying a pulsed electric field (PEF) in a method according to the present invention. As said above, preferably the method according to the present invention involves vacuum impregnation and which method is free from any PEF step. In these comparative trials, the method with and without PEF were compared, of course also compared with untreated control(s).

Cuttings of Pelargonium interspecific: Calliope M Dark Red was used as the testing material.

### Trials of Cuttings of Pelargonium

When testing the method according to the present invention, the following vacuum impregnation parameters (protocol) were used: A pressure falling time of 10 minutes, a holding time of the obtained low pressure of 1 minute and then 15 minutes rising time when the pressure was increased again to atmospheric pressure. The minimum pressure was set at 220 mbar and trehalose 10% was used as the impregnation solution.

For the PEF trial and step (not according to the present invention), the parameters used were the following: 500 V in continuous system, 250 μs pulse width and 50 PPV (pulses per volume), 0.3 KW.

For the group of cuttings that was subjected only to vacuum impregnation, that is by a method according to the present invention, an additional rinsing step was also performed.

Moreover, each group tested consisted of 80 unrooted cuttings, and not any repetitions were performed.

The results of the comparative trials are presented below in diagram 1 and table 1. It should be noted that VI stands for vacuum impregnation. The method alternative with No PEF—only VI is a method according to the present invention, however the tested alternative with PEF+VI is not a part of the present invention.

When the pelargonium cuttings were received they were processed immediately.

After the treatment, the groups were placed in perforated trays and kept inside slightly opened boxes. The boxes were stored 7 days at 8° C.

The Control Day 1 was delivered to the greenhouse for sticking the following day after reception.

Moreover, the Control was stored in the original packaging 7 days at 8° C.

After 7 days of storage the cuttings were evaluated and counted. The damaged (due to Botrytis), rotten or withered ones are removed. These are called losses before sticking.

The rooting, losses and acceptability results were obtained 21 days after sticking.

For the results below the following may be said;
A cutting is considered rooted when at least one root is coming out from the substrate used.
A cutting is considered not rooted when it has no obvious roots after this period of time but shows signs of growth.
A cutting is considered loss when it is dead/damaged, has lost most of its leaves and hasn't rooted.
A YPL (young plant) is considered acceptable if the growth is obvious, there are no signs of Botrytis, no damages in the leaves and it is rooted.

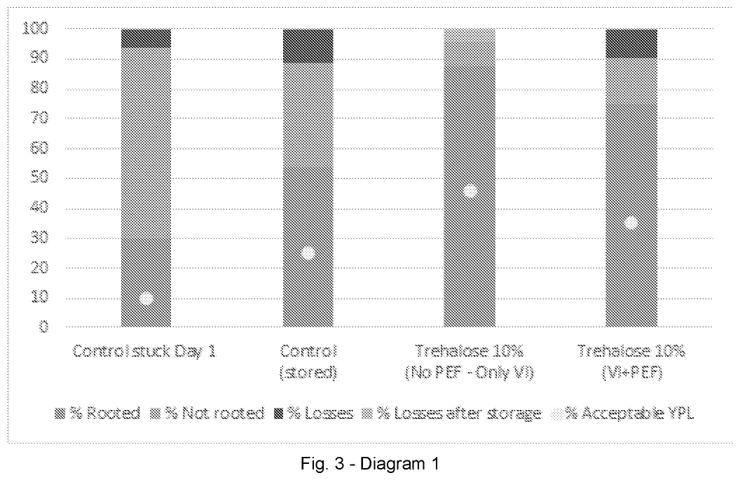

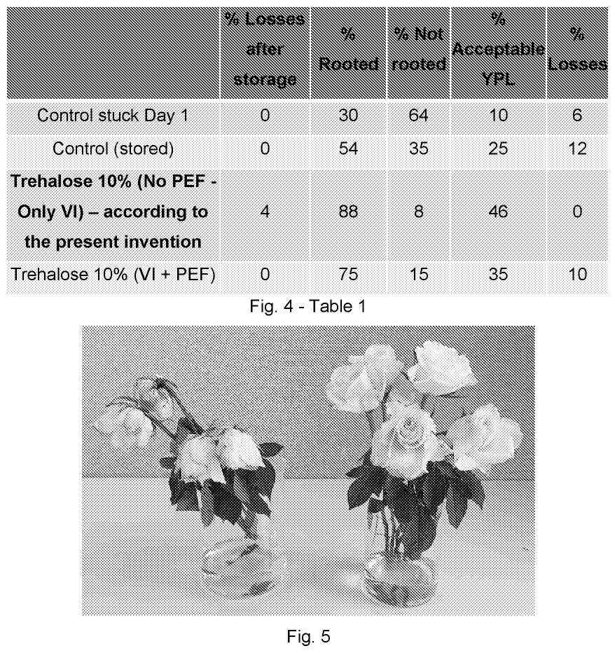

Results are shown in FIG. 3 (diagram 1) and FIG. 4 (table 1), where table 1 presents the results in diagram 1.

It should be noted that data for losses after storage were obtained after 8 days of storage.

These results imply that the method according to the present invention, i.e. comprising a vacuum impregnation (VI) step without a PEF step, is more effective than a method involving both PEF and VI, when being compared for trials of cuttings of Pelargonium interspecific: Calliope M Dark Red. Furthermore, when comparing with the control, the method according to the present invention involving only vacuum impregnation and not PEF is proven to be very effective.

### Another Performed Trial—VI on Roses

Roses (variety: Athena) were purchased form a local distributor. The roses were transported from Kenya. The roses arrived at the test site 4 days after harvest.

The treatment according to the present invention was applied to the roses immediately after the arrival. The roses were placed vertically in an impregnation solution, making sure that the flower bud was not immersed in the impregnation solution, thus only the stem and leaves were immersed. The impregnation solution contained sugar (fructose at a concentration of 2-15 wt %). Vacuum was applied reaching a minimum pressure range of 60-300 mbar, and with a total treatment time of about 12 minutes.

After that the vacuum impregnation treatment was finished, the roses were taken out from the impregnation solution. They were then immersed in water, again excluding the flower buds, to wash the sugars from the surface and then placed in a cold room for 24 hours to recover. They were in this case not dried in any way.

After 24 hours the roses were moved to room temperature in order to evaluate the results at the end user conditions. They were stored in a vase, with only the lower part of the stems immersed in water, and the water was renewed every two days.

Results show a clear improvement of the general appearance of roses that were impregnated with sugar prior to storage (see FIG. 5). The FIGURES show roses stored at room temperature for 13 days after the treatment (Right: roses treated according to the present invention, left: control roses, i.e. not treated). The browning and wilting of the flower buds are delayed for the treated roses compared to the control. Also, the treated leaves preserve freshness better.

It should be noted that also in this case PEF was not used as part of the method. This trial was performed with a method according to the present invention, that is with vacuum impregnation and without a PEF step.

### Second Aspect of the Present Invention

According to a second aspect, the present invention is directed to a method for treating one or more cut flowers each comprising a stem, possibly leaves and a flower bud, said method comprising
arranging one or more cut flowers in an impregnation solution so that at least a portion of the stem of said one or more cut flowers are immersed in the impregnation solution, but where the flower bud is free from impregnation solution; and
applying vacuum impregnation or pressure impregnation, preferably vacuum impregnation, to the impregnation solution when said at least portion of the stem are immersed into the impregnation solution, wherein the method is performed during one or more short cycles of applying vacuum impregnation or pressure impregnation, each short cycle being performed during maximum 3 minutes.

### Embodiments of the Second Aspect of the Present Invention

Below there is provided some embodiment of the second aspect of the present invention. First of all, vacuum impregnation is preferred according to the present invention. According to one embodiment, the method involves applying vacuum impregnation and wherein the method is performed during one or more short cycles of applying vacuum impregnation, each short cycle being performed during maximum 3 minutes, preferably maximum 1 minute, more preferably in the range of 5 seconds-1 minute.

Furthermore, according to yet another embodiment, the method involves vacuum impregnation in at least two phases, said two phases being a falling step when the pressure is decreased to a certain low pressure and then a pressure rising step where the pressure is increased to atmospheric level, and wherein the total treatment time for applying vacuum impregnation for said at least two phases is maximum 3 minutes, preferably maximum 1 minute, more preferably in the range of 5 seconds-1 minute. According to yet another embodiment, the method also included a minimum pressure holding step in which the low pressure is kept or substantially kept at the low pressure before the pressure rising step, and wherein the holding step preferably is performed during maximum 10 seconds, more preferably maximum 5 seconds. It is important to understand that a pressure minimum holding step is totally optional according to the present invention. Therefore, according to one embodiment, the pressure rises directly after having reached the minimum pressure level, thus a pressure minimum holding step is excluded from the method.

Moreover, according to one embodiment of the second aspect of the present invention, the method involves vacuum impregnation in a minimum pressure range of 60-300 mbar. Furthermore, according to one embodiment; the method involves vacuum impregnation in a minimum pressure range of 60-300 mbar during a total treatment time for applying vacuum impregnation in the range of 5 seconds-1 minute.

According to yet another specific embodiment of the second aspect of the invention, the method involves several vacuum impregnation cycles, preferably from atmospheric pressure to the minimum pressure and back to atmospheric pressure again in each vacuum impregnation cycle. In this regard it should be noted that the method according to the present invention also embodies a method where the pressure is increased after the minimum pressure has been reached and decreased again to the minimum pressure again (or to another level of minimum pressure). Such as procedure is not to be seen as several cycles of vacuum impregnation, however it involves a zig zag behavior with reference to the pressure decrease and increase during the procedure.

Moreover, the method according to the present invention may also imply certain additives being used in the impregnation solution, According to one specific embodiment of the second aspect, the method involves vacuum impregnation and the impregnation solution comprises at least one silver containing substance.

To give a couple of concrete examples, in table 1 below there is presented the results of two trials according to the present invention, when silver nitrate was used as an additive.

TABLE 1

| | Silver content |
|---|---|
| | in leaves, |
| Sample | mg/kg dry matter |
| Cut flower sample 1 treated according to the present | 37.32 |
| invention, day 0 | |
| Cut flower sample 1 treated according to the present | 51.71 |
| invention, day 7 | |
| Cut flower sample 1 treated according to the present | 23.10 |
| invention, day 14 | |
| Cut flower sample 2 treated according to the present | 32.49 |
| invention, day 0 | |
| Cut flower sample 2 treated according to the present | 20.07 |
| invention, day 7 | |
| Cut flower sample 2 treated according to the present | 40.50 |
| invention, day 14 | |
| Naturally occurring in cut flower, untreated control | 2.79 |

For sample 1, the impregnation solution contained silver nitrate and a commercially available surfactant, namely Greenfain.

For sample 2, the impregnation solution contained silver nitrate and silica, and Greenfain.

It should be noted that different types of silver carrier substances and different types of surfactants may be used according to the present invention.

Although it should be noted that the exact measurement levels are not certain (see for instance the silver content level of sample 2 when comparing after 7 days and 14 days), which may be understood from the explanation of the measurement level below, it should be clear that the samples treated according to the present invention exhibit a silver content well above the naturally occurring level.

The measurement method was conducted as follows. The leaves, after treatment at certain days or without treatment in the control, were dried at 40° C. and then milled. Around 0.5 g of the milled material was digested with 7 ml concentrated Supra pure HNO₃ and 3 ml milli-Q water in closed vessels using a microwave, Mars 5 from CEM. The digested samples were then diluted up to 50 ml with water prior to analysis with ICP-OES, Optima 8300 from Perkin Elmer. It should be noted that Inductively Coupled Plasma Atomic Emission Spectroscopy (ICP-AES (also called ICP-OES)) is a technique to determine low-concentrations, and ultra-low-concentrations of elements in a mixture sample. Atomic elements are led through a plasma source where they become ionized. Then, these ions are sorted on account of their mass (there are already standards of mass for every known atom).

As may be understood from above, according to the present invention the silver content in the leaves may be well above 10.0 mg/kg dry substance. In line with this, according to one specific embodiment of the present, the cut flower comprises at least one leaf, and wherein the method provides a silver content of at least 3.0 mg/kg dry substance in said at least one leaf, preferably at least 5.0 mg/kg dry substance in said at least one leaf, more preferably at least 7.0 mg/kg dry substance in said at least one leaf, more preferably at least 10.0 mg/kg dry substance in said at least one leaf, more preferably at least 15.0 mg/kg dry substance in said at least one leaf, more preferably at least 20.0 mg/kg dry substance in said at least one leaf, more preferably at least 25.0 mg/kg dry substance in said at least one leaf, most preferably at least 30.0 mg/kg dry substance in said at least one leaf, preferably as measured up to at least 7 days after treatment, more preferably as measured up to 14 days after treatment.

Moreover, according to the present invention also other parts of the cut flower may have an increased silver content. As an example, according to one specific embodiment of the present invention, the cut flower also comprises a stem and wherein the method provides a silver content of at least 10.0 mg/kg dry substance in the stem.

As is hinted above, according to these embodiments of the present invention there is enabled to increase the silver content in at least the leaves of the cut flower.

Moreover, according to one preferred embodiment of the second aspect, the method involves vacuum impregnation and the impregnation solution comprises at least one surfactant, preferably at least one anionic surfactant. By using a surfactant according to the present invention, the surface tension of the impregnation solution is broken, which in turn enables to provide much more of the active components (treatment liquid) into the leaves and stem of the cut flower. It is this starting point according to the present invention which enables to increase the active silver component in the leaves.

Furthermore, when performing the vacuum impregnation, gases, such as air, inside of the cut flower is replaced with liquid. The liquid or impregnation solution may have different functions depending in the components contain in the impregnation solution. Possible functionalities are to add nutrition and prevent growth of bacteria and fungus. Furthermore, it may work as an ethylene blocker. In this regard it should be noted that silver has the ability to block ethylene responses in plants, proving the great effect of the concept according to the present invention.

By treating the leaves according to the present invention an osmosis reaction occurs. This in turn implies that the cut flower increases water intake, which in turns implies a longer shelf life.

The vacuum impregnation method according to the present invention is performed in a treatment chamber. The pressure is then decreased to a certain minimum pressure, where air leaves different voids in the cut flower being treated. At the same time, the treatment chamber is filled with impregnation solution. When the pressure is increased again the voids are filled with the impregnation solution instead of air. Again, the use of a surfactant according to the present invention implies that more active component, i.e. at least silver, penetrates into the cut flower, at least into the leaves and stem(s) of the cut flower.

Moreover, silver may be provided into the impregnation solution in different forms. One example is as silver nitrate being provided into the impregnation solution.

Furthermore, different types of surfactants may be used. According to one embodiment of the present invention, said at least one surfactant is an anionic surfactant. Anionic surfactants which are readily biodegradable may be relevant to use according to the present invention.

Moreover, it may also be of interest how to perform the actual impregnation. According to one specific embodiment of the present invention, the step of arranging one or more cut flowers in an impregnation solution is performed so that at least a portion of the stem of said one or more cut flowers are immersed in the impregnation solution, but where the flower bud is free from impregnation solution, and wherein the step of applying vacuum impregnation or pressure impregnation, preferably vacuum impregnation, is performed to the impregnation solution when said at least portion of the stem are immersed into the impregnation solution. According to this embodiment, the method ensures that the flower bud is free from impregnation solution. This may also be of importance in some case and is a unique aspect of the present invention.

In addition to said at least one surfactant, the impregnation solution may also comprise other substances. First of all, according to one embodiment, the method involves vacuum impregnation and the impregnation solution comprises at least one sugar component, preferably wherein said at least on sugar component is glucose, trehalose and/or fructose, or a sugar alcohol, preferably sorbitol, or a combination thereof.

Moreover, the impregnation solution may also comprise additives. In relation to the impregnation solution it should be noted that this may comprise at least one sugar without any additives, at least one sugar and additives, or only additives. At least one surfactant is, however, always present to obtain the enhanced results of silver content in the leaves.

In relation to additives, many different are possible. According to one specific embodiment of the second aspect of the present invention, the impregnation solution comprises at least one additive being a vitamin, mineral, ethylene controller, antioxidant, hormone, nutrient, antimicrobial, or a combination thereof.

Some additional specific alternatives of interest are presented below.

Growth regulators
Paclobutrazol (PBZ)
Naphthaleneacetic acid (NAA)
Indole butyric acid (IAA)
Thidiazuron (TDZ)
Benzylaminopurine (BAP)
Adenine
Gibberellins (GA:s)

### Stress Response Regulators

Jasmonic acid (JA)
Salicylic acid (SA)

All of the above are possible in different combinations according to the present invention.

According to yet another specific embodiment of the present invention, the method involves vacuum impregnation and the impregnation solution comprises at least one additive of folic acid, gamma-aminobutyric acid (GABA), 1-methylcyclopropene (1-MCP), or a combination thereof. Other steps may also be part of the method according to the present invention. According to one specific embodiment, the method involves a subsequent washing step comprising immersing said one or more cut flowers into water to wash sugars and/or other substances from the surface of the cut flower, and wherein the immersing is performed so that the flower bud is excluded from being immersed. It should, however, be noted that using a washing step is totally optional according to the present invention.

Moreover, in relation to a possible washing step it should also be noted that this does not have to performed in a vacuum treatment chamber as further explained below, but can be made in another unit in the system. Nevertheless, such a washing step is totally optional.

Moreover, according to another embodiment, the cut flowers are subjected to a cooling step after the vacuum impregnation. The cooling step may suitably be performed at a temperature of 2-10° C., such as suitably in a range of 5-10° C. Moreover, according to one embodiment, the cooling step is performed during at least 6 hours, preferably at least 12 hours, such as in the range of 12-24 hours. Furthermore, the cooling should be performed in a controlled storing environment. According to one embodiment, the cooling step is performed in a cooling environment involving a humidity of above 50%. Moreover, the cooling and transportation may be performed in a modified atmosphere. Furthermore, the cooling may suitably be performed in an aerated room so that the surfaces of the leaves dry on themselves.

In relation to the above it should be mentioned that the cooling step may also be seen as a recovery step in a cooled or low temperature.

Moreover, according to yet another embodiment, freezing is applied instead of cooling. Cooling is, however, preferred.

Moreover, according to yet another embodiment, the impregnation is a partial impregnation, preferably wherein the impregnation is a partial impregnation where the weight gain is 50% of the full impregnation weight gain.

Prevention of microbial contamination is important. According to one embodiment of the present invention, the method also comprises an active step for preventing microbial contamination of the (aqueous) impregnation solution. According to one specific embodiment, the active step for preventing microbial contamination involves adding one or more antimicrobial agents to the impregnation solution, preferably wherein the active step for preventing microbial contamination involves an active treatment of the impregnation solution. Moreover, according to yet another embodiment, the impregnation solution is recirculated and reused, preferably as an active step for preventing microbial contamination.

According to one specific embodiment of the present invention, said method is performed without performing a prior, simultaneous or subsequent PEF (pulsed electrical field) treatment. PEF may be involved after the impregnation step, but this is optional. In this regard it should be noted that only the impregnation is mandatory. Therefore, according to yet another specific embodiment, the method also involves a step of applying PEF (pulsed electric field).

According to one embodiment, the method involves vacuum impregnation and the cut flowers are cut roses.

The present invention also refers to a system intended to perform the method discussed above. In line with this, according to one embodiment, the present invention refers to a system intended for treating one or more cut flowers each comprising a stem, possibly leaves and a flower bud, to vacuum impregnation, said system comprising a vacuum generation system comprising at least one vacuum treatment container with a vacuum treatment chamber and a lid, said at least one vacuum treatment container being
arranged for enabling arranging one or more cut flowers in an impregnation solution so that at least a portion of the stem of said one or more cut flowers are immersed in the impregnation solution, but where the flower bud is free from impregnation solution; and
arranged for applying vacuum impregnation to the impregnation solution when said at least portion of the stem are immersed into the impregnation solution, so that a total treatment time for applying vacuum impregnation is enabled within less than 3 minutes.

The present invention refers to a fast vacuum system enabling for the method with short vacuum impregnation cycles according to the present invention. There are challenges to provide a system which is suitable for short vacuum impregnation cycles, which challenges are referred to in the below description of embodiments according to the present invention.

According to one embodiment of the present invention, said at least one vacuum treatment container is arranged to enable vacuum treatment directly when the lid is closed, preferably automatically, more preferably enabled by means of a lid sensor arranged to detect lid closure, preferably said system is arranged to suck the lid in tight closure after detection by the lid sensor. With reference to this performance, to make the system quick to maneuver the system doesn't need to have any buttons to start the treatment. The system doesn't need any locks or door handles either to close the vacuum treatment container. This is important since every second that can be spared is valuable to make the production more efficient. As soon as the products have been entered into the vacuum treatment chamber it is important to minimize every time-consuming step. Therefore, to remove all those time consuming and unpractical steps the treatment starts as soon as the lid is closed to the vacuum chamber. This is accomplished by a lid sensor detecting when the lid is closed and which enables that the lid is sucked in place and starts the treatment.

Furthermore, also the lid arrangement according to the present invention has preferable features. The lid should enable for an airtight arrangement at a very low under-pressure as well as at a very high under-pressure. According to the present invention, the arrangement makes sure that the lid is directly airtight when the lid sensor detects that the lid is closed. It also makes sure that the sealing can withstand the high under-pressure during the treatment. This arrangement design according to the present invention makes sure that as much time as possible is saved and that the lid becomes very easy to close.

According to yet another embodiment of the present invention, the lid is freely moving in at least three directions. One first direction is that the lid can be turned towards the vacuum treatment chamber. It is not suitable with only this direction since usually the precision in manufacturing is not good enough for not creating any tiny slots where the air can leak. This is usually handled by adding for example several locks that presses the lid hard towards the sealing. To remove such time-consuming and complicated solutions the lid according to the present invention is arranged so it can move in at least two more directions, that is totally in at least three directions. According to yet another embodiment of the present invention, the lid is arranged to be freely moving in at least 0.4 degrees, preferably in a range of 0.4-5 degrees, both backwards and to the sides. This makes sure that the lid can be attached to the vacuum treatment chamber without any air slots and this is of great importance for the lid to be sucked in place. In this regard it should be noted that the direction does not only have to be downwards, but instead the lid may also be pivotable laterally.

Furthermore, according to yet another embodiment, the lid is arranged to open automatically after performed treatment, preferably by means of a lid opening unit, more preferably wherein the lid opening unit is a spring or rod, such as a hydraulic rod, pneumatic rod, or a gas spring. The treated products in the vacuum treatment chamber need to be removed after the treatment. It is then important to remove every time-consuming step that could be caused by a complicated lid-opening, for example pressing buttons, unlocking several locks, or turning a door handle. A lid opening unit according to the present invention may provide a solution for this. In one configuration of the system the lid is opened from 5 to 100 mm by a spring. In another configuration the lid is opened by a gas driven spring. In another configuration the lid is opened completely by the incorporation of a hydraulic rod. These solutions serve several purposes. One is that the system clearly signals to the user that the treatment is done. Another purpose is to help the user to open the lid. Furthermore, yet another purpose is to save time for the user, so that no extra time is spent on buttons, locks or door-handles. In relation to the above it may also be said that a signal light may also be used on each vacuum chamber to show the status of each treatment process.

Moreover, as the lid can move freely in 3 directions, the lid would have to be pushed down at two opposite sides of the lid at the same time. To simplify in this regard, the lid may be arranged with a lid closing unit, preferably wherein said lid closing unit is arranged to push down the lid with a force in the range of 2-150 N. This makes it possible for the operator to close the lid by only pushing down the lid at the outer side. The inner side will always have the same pressure towards the sealing. In relation to the above it may further be said that the lid closing unit and lid opening unit may be one and the same unit according to the present invention.

According to the present invention there is no need for additional pumps more than the vacuum pump. Therefore, according to the present invention, the system comprises a vacuum pump arranged to provide vacuum into said at least one vacuum treatment container and also an impregnation solution into said at least one vacuum treatment container. The vacuum pump is used to suck the liquid into the vacuum tank. This simplifies the system so that there is no need for an extra liquid pump.

Furthermore, according to yet another embodiment, a level sensor is arranged in said at least one vacuum treatment container. The impregnation solution (treatment liquid) may sometimes be light sensitive. In such cases it is important that the liquid is protected from light. To achieve this, the vacuum treatment chamber is designed with a “middle bottom” that is made in such a way that minimal light reaches the treatment liquid. The middle bottom is also possible to set in different heights, depending on the size of the product that shall be treated. The liquid height may be monitored by a level sensor, so that the liquid height is kept below the “middle bottom” when the lid is opened. When the lid is closed the liquid is sucked in by the vacuum and a valve is closed when the level reaches a certain height. When the treatment is done, the liquid is sucked out so that the liquid level is kept below the “middle bottom” and the lid is opened.

As mentioned above, the impregnation liquid often deteriorates by light so it is important to keep the liquid in dark. It is also beneficial if the system can skip an extra buffer tank to make sure that the liquid is stored in darkness. This may be accomplished by two things. The first thing is that the liquid is mixed directly at the system with tap water or other liquid such as ionized water. As one possibility, this may be accomplished by dosing pumps that injects a concentrated liquid into the water pipe. This enables to minimize the size of the tanks for the treatment liquid. The second thing is that the treatment liquid is only stored below a “middle-bottom”, as mentioned above. This middle bottom makes sure that almost no light reaches the treatment liquid. When a treatment is started the liquid is sucked from the other tanks. This has two advantages. One is that there is no need for an extra buffer tank. The other advantage is that the empty time goes faster, since the liquid is both sucked out from one tank and sucked in from another tank.

Moreover, according to yet another embodiment of the present invention, the system comprises several vacuum treatment containers in connection with each other, such as a range of 2-10 vacuum treatment containers. It is of course of interest to use as little impregnation solution/treatment liquid as possible in the system. This is accomplished by reusing the liquid in several vacuum treatment containers. The system can contain for example 2 to 10 vacuum chambers and only liquid for one vacuum chamber is needed. When one treatment is finished the liquid is sucked into the next vacuum chamber.

As only one chamber at a time can perform a treatment the next vacuum treatment chamber cannot be started until the previous is done. This could cause unwanted waiting time for an operator. According to the present invention it is possible to incorporate several vacuum treatment chambers and ensure that a subsequent vacuum treatment chamber is closed and is in waiting mode when the former vacuum treatment chamber is in treatment. Based on this, according to one embodiment of the present invention there is disclosed a method for operation of a system according to the present invention, wherein the system comprises several vacuum treatment containers in connection with each other, and wherein the method involves closing the lid of a subsequent vacuum treatment container by use of vacuum and starting the treatment in said subsequent vacuum treatment container automatically when the former treatment is finalized.

Furthermore, according to yet another embodiment of the present invention, the system comprises a vacuum buffer tank. In some treatments it is important to have an extremely fast drop in vacuum. This is hard to achieve with commercial vacuum pumps, since then the vacuum pump becomes extremely large and expensive. To achieve this fast drop in vacuum, the vacuum treatment chamber can be combined with a buffer tank which is larger than the vacuum treatment chamber. The buffer tank is emptied by a vacuum pump when there is time, for example between the treatments or when the pressure is rising in the vacuum treatment chamber. According to this embodiment the vacuum pump will not be the bottleneck with reference to how fast the pressure can be dropped. This makes it possible to drop the pressure in a very short time, for example within one second instead of for example 60 seconds. In relation to the above, the following may also be mentioned. First of all, the above is dependent on the size of the buffer tank and the end pressure achieved. It does not operate like a tank with pressurized gas which may hold a pressure several times above a certain intended working pressure in a connected vessel. In a vacuum system according to the present invention it is only possible to obtain −1 bar in a vacuum tank and if the pressure evens out, the pump must be large enough to draw air from the whole system fast enough to lower the pressure for the treatment to be done correctly.

According to yet another embodiment of the present invention, said at least one vacuum treatment container comprises sections, said sections arranged to enable to treat cut flowers bunch wise, such as a range of 2-12 sections. Usually flowers are handled in a bunch of 8 to 16 flowers. As it is beneficial to keep the same number of flowers per bunch in order to simplify for the operators, the vacuum treatment chamber may be divided into sections, for example 2 to 12 sections. The operator that takes out the flowers can then take out all the flowers in a section and directly place them into a bucket. This saves time and makes it easier for the operator to handle the system.

Furthermore, it should be noted that the method according to the present invention may involve using several vacuum short vacuum cycles according to the present invention in one and the same vacuum treatment chamber without opening the lid or restarting the treatment. This may be beneficial when treating certain flowers and with certain procedures (set pressures and times). Based on this, according to one embodiment, said method involves performing several vacuum treatments in one and the same vacuum treatment container before ending the entire treatment and removing the cut flowers from the vacuum treatment container.

### FURTHER EXAMPLES AND DRAWINGS

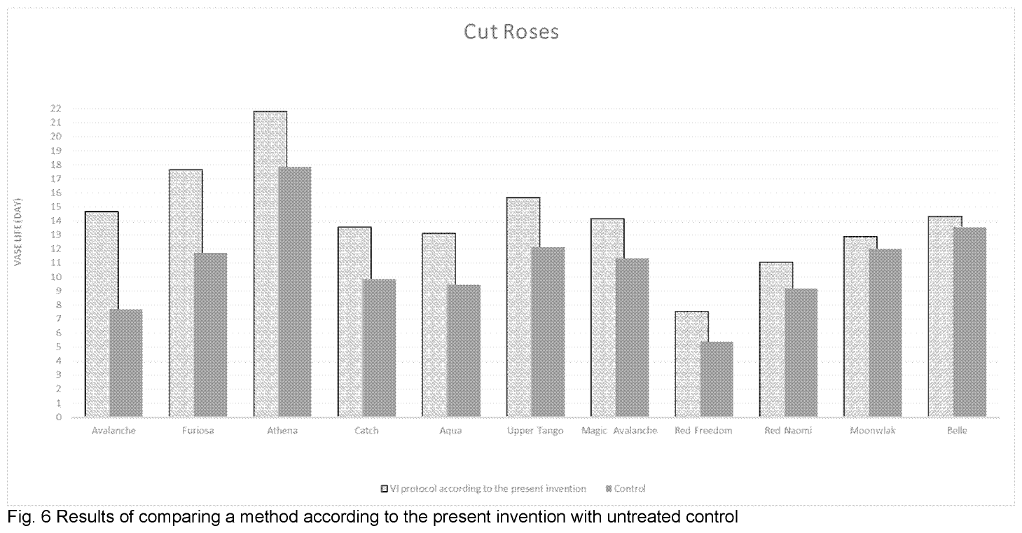

Different verities of cut roses were treated. The impregnation solution used contained silver nitrate and Greenfain. The vacuum impregnation protocols used were based on treatment during 30 and 40 seconds, respectively, at 100 mbar, 200 mbar and 300 mbar. Each trial was repeated twice. In FIG. 6 there is shown the best results for each type of cut rose (average on both trials for that best protocol) for treated cut roses according to the present invention and for control (non-treated), where the results are based on the vase life. The roses after treatment and the control were placed in water. As may be seen, the method according to the present invention provided an improvement for all verities of cut roses.

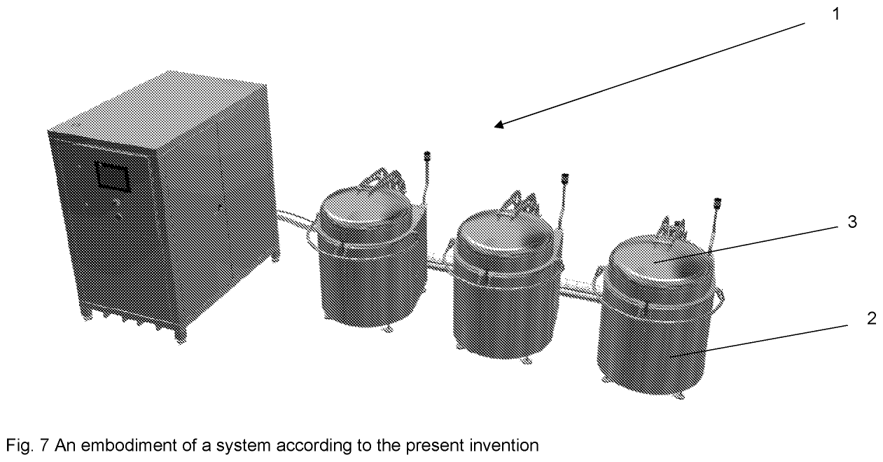

In FIG. 7 there is shown one embodiment of a system according to the present invention. As may be seen, the system 1 comprises several vacuum treatment containers 2, each having a lid 3. Furthermore, according to this embodiment, there is also arranged a vacuum buffer tank 4 in the system 1.

Moreover, it should be noted that loading of cut roses into the vacuum treatment containers 2 may be made in different ways, such as manually by hand or by means of a robot or the like.

### CLAUSES—A SECOND ASPECT OF THE PRESENT INVENTION

1. A method for treating one or more cut flowers each comprising a stem, possibly leaves and a flower bud, said method comprising
   arranging one or more cut flowers in an impregnation solution so that at least a portion of the stem of said one or more cut flowers are immersed in the impregnation solution, but where the flower bud is free from impregnation solution; and
   applying vacuum impregnation or pressure impregnation, preferably vacuum impregnation, to the impregnation solution when said at least portion of the stem are immersed into the impregnation solution, wherein the method is performed during one or more short cycles of applying vacuum impregnation or pressure impregnation, each short cycle being performed during maximum 3 minutes.
2. The method according to claim 1, wherein the method involves applying vacuum impregnation and wherein the method is performed during one or more short cycles of applying vacuum impregnation, each short cycle being performed during maximum 3 minutes, preferably maximum 1 minute, more preferably in the range of 5 seconds-1 minute.
3. The method according to claim 1 or 2, wherein the method involves vacuum impregnation in at least two phases, said two phases being a falling step when the pressure is decreased to a certain low pressure and then a pressure rising step where the pressure is increased to atmospheric level, and wherein the total treatment time for applying vacuum impregnation for said at least two phases is maximum 3 minutes, preferably maximum 1 minute, more preferably in the range of 5 seconds-1 minute.
4. The method according to claim 3, wherein the method also included a minimum pressure holding step in which the low pressure is kept or substantially kept at the low pressure before the pressure rising step, and wherein the holding step preferably is performed during maximum 10 seconds, more preferably maximum 5 seconds.
5. The method according to any of claims 1-4, wherein the method involves vacuum impregnation in a minimum pressure range of 60-300 mbar.
6. The method according to claim 5, wherein the method involves vacuum impregnation in a minimum pressure range of 60-300 mbar during a total treatment time for applying vacuum impregnation in the range of 5 seconds-1 minute.
7. The method according to any of the preceding claims, wherein the method involves several vacuum impregnation cycles, preferably from atmospheric pressure to the minimum pressure and back to atmospheric pressure again in each vacuum impregnation cycle.
8. The method according to any of claims 1-7, wherein the method involves vacuum impregnation and the impregnation solution comprises at least one silver containing substance.
9. The method according to claim 8, wherein the cut flower comprises at least one leaf, and wherein the method provides a silver content of at least 3.0 mg/kg dry substance in said at least one leaf, preferably at least 5.0 mg/kg dry substance in said at least one leaf, more preferably at least 7.0 mg/kg dry substance in said at least one leaf, more preferably at least 10.0 mg/kg dry substance in said at least one leaf, more preferably at least 15.0 mg/kg dry substance in said at least one leaf, more preferably at least 20.0 mg/kg dry substance in said at least one leaf, more preferably at least 25.0 mg/kg dry substance in said at least one leaf, most preferably at least 30.0 mg/kg dry substance in said at least one leaf, preferably as measured up to at least 7 days after treatment, more preferably as measured up to 14 days after treatment.
10. The method according to any of claim 8 or 9, wherein the cut flower also comprises a stem and wherein the method provides a silver content of at least 10.0 mg/kg dry substance in the stem.
11. The method according to any of claims 1-10, wherein the method involves vacuum impregnation and the impregnation solution comprises at least one surfactant, preferably at least one anionic surfactant.
12. The method according to any of claims 1-11, wherein the method involves vacuum impregnation and the impregnation solution comprises at least one sugar component, preferably wherein said at least on sugar component is glucose, trehalose and/or fructose, or a sugar alcohol, preferably sorbitol, or a combination thereof.
13. The method according to any of claims 1-12, wherein the method involves vacuum impregnation and the impregnation solution comprises at least one additive being a vitamin, mineral, ethylene controller, antioxidant, hormone, nutrient, antimicrobial, or a combination thereof.
14. The method according to any of claims 1-13, wherein the method involves vacuum impregnation and the impregnation solution comprises at least one additive of folic acid, gamma-aminobutyric acid (GABA), 1-methylcyclo-propene (1-MCP), or a combination thereof.
15. The method according to any of the preceding claims, wherein the method involves a subsequent washing step comprising immersing said one or more cut flowers into water to wash sugars and/or other substances from the surface of the cut flower, and wherein the immersing is performed so that the flower bud is excluded from being immersed
16. The method according to any of the preceding claims, wherein the cut flowers are subjected to a cooling step after the vacuum impregnation.
17. The method according to claim 15 or 16, wherein the cooling step is performed at a temperature of 5-10° C., preferably wherein the cooling step is performed during at least 6 hours, preferably at least 12 hours.
18. The method according to any of claims 15-17, wherein the cooling step is performed in a cooling environment involving a humidity of above 50%.
19. The method according to any of claims 1-18, wherein said method is performed without performing a prior, simultaneous or subsequent PEF (pulsed electrical field) treatment.
20. The method according to any of claims 1-18, wherein the method also involves a step of applying PEF (pulsed electric field).
21. The method according to any of the preceding claims, wherein the impregnation is a partial impregnation, preferably wherein the impregnation is a partial impregnation where the weight gain is 50% of the full impregnation weight gain.
22. The method according to any of the preceding claims, wherein the method involves vacuum impregnation and the cut flowers are cut roses.
23. A system (1) intended for treating one or more cut flowers each comprising a stem, possibly leaves and a flower bud, to vacuum impregnation, said system comprising a vacuum generation system comprising at least one vacuum treatment container (2) with a vacuum treatment chamber and a lid (3), said at least one vacuum treatment container (2) being
   arranged for enabling arranging one or more cut flowers in an impregnation solution so that at least a portion of the stem of said one or more cut flowers are immersed in the impregnation solution, but where the flower bud is free from impregnation solution; and
   arranged for applying vacuum impregnation to the impregnation solution when said at least portion of the stem are immersed into the impregnation solution, so that a total treatment time for applying vacuum impregnation is enabled within less than 3 minutes.
24. The system (1) according to claim 23, wherein said at least one vacuum treatment container (2) is arranged to enable vacuum treatment directly when the lid (3) is closed, preferably automatically, more preferably enabled by means of a lid sensor arranged to detect lid closure, preferably said system is arranged to suck the lid in tight closure after detection by the lid sensor.
25. The system (1) according to claim 23 or 24, wherein the lid (3) is freely moving in at least three directions.
26. The system (1) according to claim 25, wherein the lid (3) is arranged to be freely moving in at least 0.4 degrees, preferably in a range of 0.4-5 degrees, both backwards and to the sides.
27. The system (1) according to any of claims 23-26, wherein the lid (3) is arranged to open automatically after performed treatment, preferably by means of a lid opening unit, more preferably wherein the lid opening unit is a spring or rod, such as a hydraulic rod, pneumatic rod or a gas spring.
28. The system (1) according to any of claims 23-27, wherein the lid (3) is arranged with a lid closing unit, preferably wherein said lid closing unit is arranged to push down the lid (3) with a force in the range of 2-150 N.
29. The system (1) according to any of claims 23-28, wherein the system (1) wherein the system (1) comprises a vacuum pump arranged to provide vacuum into said at least one vacuum treatment container (2) and also an impregnation solution into said at least one vacuum treatment container (2).
30. The system (1) according to any of claims 23-29, wherein a level sensor is arranged in said at least one vacuum treatment container (2).
31. The system (1) according to any of claims 23-30, wherein the system (1) comprises several vacuum treatment containers (2) in connection with each other, such as a range of 2-10 vacuum treatment containers (2).
32. The system (1) according to any of claims 23-31, wherein the system (1) comprises a vacuum buffer tank (4).
33. The system (1) according to any of claims 23-32, wherein said at least one vacuum treatment container (2) comprises sections, said sections arranged to enable to treat cut flowers bunch wise, such as a range of 2-12 sections.
34. A method for operation of a system (1) according to any of claims 23-33, wherein said method involves performing several vacuum treatments in one and the same vacuum treatment container (2) before ending the entire treatment and removing the cut flowers from the vacuum treatment container (2).
35. A method for operation of a system (1) according to any of claims 31-33, wherein the system (1) comprises several vacuum treatment containers (2) in connection with each other, and wherein the method involves closing the lid (3) of a subsequent vacuum treatment container by use of vacuum and starting the treatment in said subsequent vacuum treatment container automatically when the former treatment is finalized.

1.-34. (canceled)

35. A method for treating a biological material, said method comprising exposing the biological material to vacuum impregnation or pressure impregnation, preferably vacuum impregnation, in an aqueous impregnation solution comprising at least one surfactant.

36. The method according to claim 35, wherein said at least one surfactant is an anionic surfactant.

37. The method according to claim 35, wherein the method is performed without performing a prior, simultaneous or subsequent PEF (pulsed electrical field) treatment.

38. The method according to claim 35, wherein the method involves vacuum impregnation in at least three phases, said at least three phases being a pressure falling step when the pressure is decreased to a certain low pressure, then a pressure holding step in which the low pressure is kept or substantially kept at the low pressure, and a pressure rising step where the pressure is increased to atmospheric level, preferably the pressure falling step is performed during a time of maximum 10 minutes, preferably maximum 5 minutes, more preferably maximum 3 minutes, preferably the pressure holding step is performed during maximum 5 minutes, preferably maximum 3 minutes, more preferably maximum 2 minutes, preferably the pressure rising step is performed during maximum 10 minutes, preferably maximum 5 minutes, more preferably maximum 3 minutes, preferably wherein the method involves vacuum impregnation in a minimum pressure range of 50-500 mbar, preferably in the range of 60-300 mbar.

39. The method according to claim 35, wherein the aqueous impregnation solution comprises at least one sugar being glucose, trehalose and/or fructose, or a sugar alcohol, preferably sorbitol or glycerol, or a combination thereof, and/or wherein the impregnation solution comprises at least one additive being a vitamin, mineral, ethylene controller, hormone, e.g. a growth hormone, nutrient, antimicrobial, fertilizer, anti-foaming agent, or a combination thereof, and/or wherein the impregnation solution comprises at least one additive of folic acid, gamma-aminobutyric acid (GABA), ethylene blockers, e.g. 1-methylcyclopropene (1-MCP), pantothenic add, amino adds, e.g. cysteine, plant hormones, e.g. IBA, an antiseptic agent, e.g. silver nitrate, or a combination thereof, and/or wherein one or more growth agents are added to the aqueous impregnation solution.

40. The method according to claim 35, wherein the method also comprises applying a drying step to the biological material, subsequent to vacuum impregnation, for removing water/moisture from surfaces of the plant material before packing the treated plant material.

41. The method according to claim 35, for treating one or more cut flowers each comprising a stem, possibly one or more leaves and a flower bud, said method comprising
arranging one or more cut flowers in an impregnation solution so that at least a portion of the stem of said one or more cut flowers are immersed in the impregnation solution, but where the flower bud is free from impregnation solution; and
applying vacuum impregnation or pressure impregnation, preferably vacuum impregnation, to the impregnation solution when said at least portion of the stem are immersed into the impregnation solution,
wherein the method is performed during one or more short cycles of applying vacuum impregnation or pressure impregnation, each short cycle being performed during maximum 3 minutes, preferably maximum 1 minute, more preferably in the range of 5 seconds-1 minute.

42. The method according to claim 41, wherein the impregnation solution comprises at least one silver containing substance, and wherein the silver content is at least 3.0 mg/kg dry substance in said at least one or more leaves, preferably at least 5.0 mg/kg dry substance in said at least one leaf, more preferably at least 7.0 mg/kg dry substance in said at least one leaf, more preferably at least 10.0 mg/kg dry substance in said at least one leaf, more preferably at least 15.0 mg/kg dry substance in said at least one leaf, more preferably at least 20.0 mg/kg dry substance in said at least one leaf, more preferably at least 25.0 mg/kg dry substance in said at least one leaf, most preferably at least 30.0 mg/kg dry substance in said at least one leaf, after treatment, preferably as measured up to at least 7 days after treatment, more preferably as measured up to 14 days after treatment.

43. The method according to claim 41, wherein the cut flower also comprises a stem and wherein the silver content is at least 10.0 mg/kg dry substance in the stem after treatment, preferably as measured up to at least 7 days after treatment, more preferably as measured up to 14 days after treatment.

44. The method according to claim 35, wherein the method also comprises an active step for preventing microbial contamination of the aqueous impregnation solution, preferably the active step for preventing microbial contamination involves adding one or more antimicrobial agents to the aqueous impregnation solution, preferably wherein the active step for preventing microbial contamination involves an active treatment of the aqueous impregnation solution, and/or wherein the aqueous impregnation solution is recirculated and reused, preferably as an active step for preventing microbial contamination.

45. The method according to claim 35, wherein the method involves a subsequent washing step comprising immersing the treated biological material into water to wash sugars from the surface of the treated biological material, preferably the biological material is directly subjected to a cooling step after the washing step, said cooling step being a recovering step, more preferably the cooling step is performed at a temperature of 5-10° C., more preferably the cooling step is performed during at least 6 hours, preferably at least 12 hours.

46. The method according to claim 35, wherein the impregnation is a partial impregnation, preferably wherein the impregnation is a partial impregnation where the biological material receives a maximum of a 50% weight gain after the partial impregnation.

47. The method claim 35, wherein a resting period is applied subsequent to the vacuum or pressure impregnation, preferably the resting period is performed in a relative humidity of at least 60% and in a temperature range of 4-10° C., preferably the resting period involves removing water from surfaces of the plant material, preferably the resting period involves putting the biological material on a net material to remove water from surfaces of the biological material, optionally the method involves a subsequent freezing step.

48. The method according to claim 35, wherein the method involves storing the biological material in a controlled storing environment, preferably the storing environment involves a temperature of 4-10° C., preferably wherein the storing environment involves a humidity of above 50%, preferably wherein the storing is performed by incorporating the biological material into one or more package with modified atmosphere.

49. The method according to claim 35, wherein the biological material is a plant material, preferably a plant material comprising one or more sprouts, cuttings or cut flowers, preferably cuttings or flowers.

50. A system intended for treating one or more cut flowers each comprising a stem, possibly leaves and a flower bud, to vacuum impregnation, said system comprising a vacuum generation system comprising at least one vacuum treatment container with a vacuum treatment chamber and a lid, said at least one vacuum treatment container being
arranged for enabling arranging one or more cut flowers in an impregnation solution so that at least a portion of the stem of said one or more cut flowers are immersed in the impregnation solution, but where the flower bud is free from impregnation solution; and
arranged for applying vacuum impregnation to the impregnation solution when said at least portion of the stem are immersed into the impregnation solution, so that a total treatment time for applying vacuum impregnation is enabled within less than 3 minutes.

51. The system according to claim 50, wherein said at least one vacuum treatment container is arranged to enable vacuum treatment directly when the lid is closed, preferably automatically, more preferably enabled by means of a lid sensor arranged to detect lid closure, preferably said system is arranged to suck the lid in tight closure after detection by the lid sensor.

52. The system according to claim 50, wherein the lid is freely moving in at least three directions, preferably the lid is arranged to be freely moving in at least 0.4 degrees, preferably in a range of 0.4-5 degrees, both backwards and to the sides.

53. The system according to claim 50, wherein the lid is arranged to open automatically after performed treatment, preferably by means of a lid opening unit, more preferably wherein the lid opening unit is a spring or rod, such as a hydraulic rod, pneumatic rod or a gas spring, preferably the lid is arranged with a lid closing unit, preferably wherein said lid closing unit is arranged to push down the lid with a force in the range of 2-150 N.

54. The system according to claim 50, wherein the system wherein the system comprises a vacuum pump arranged to provide vacuum into said at least one vacuum treatment container and also an impregnation solution into said at least one vacuum treatment container.

55. The system according to claim 50, wherein a level sensor is arranged in said at least one vacuum treatment container.

56. The system according to claim 50, wherein the system comprises several vacuum treatment containers in connection with each other, such as a range of 2-10 vacuum treatment containers.

57. The system according to claim 50, wherein the system comprises a vacuum buffer tank.

58. The system according to claim 50, wherein said at least one vacuum treatment container comprises sections, said sections arranged to enable to treat cut flowers bunch wise, such as a range of 2-12 sections.
